(19) United States
(12) Patent Application Publication
(10) Pub. No.: US 2026/0208446 A1
(43) Pub. Date: Jul. 23, 2026

(54) THERMAL CONTROL SYSTEM FOR LASER-BASED THREE-DIMENSIONAL POWDER FUSION MANUFACTURING

(71) Applicant: International Business Machines Corporation, Armonk, NY (US)

(72) Inventors: Binoy Thomas, Kozhikode (IN); Sarbajit Kumar Rakshit, Kolkata (IN); Sudheesh S. Kairali, Kozhikode (IN)

(21) Appl. No.: 19/026,957

(22) Filed: Jan. 17, 2025

(51) Int. Cl. B29C 64/393; B29C 64/153; B29C 64/268; B29C 64/282; B33Y 10/00; B33Y 50/02

(52) U.S. Cl. CPC B29C 64/393; B29C 64/153; B29C 64/268; B29C 64/282; B33Y 10/00; B33Y 50/02

(57) ABSTRACT

A method for thermal control of laser-based three dimensional (3D) powder fusion manufacturing is provided. The method includes directing a laser beam into a powder bed for fabricating a 3D object by powder bed fusion, analyzing historical data and powder specifications relating to the 3D object and powder in the powder bed and dynamically adjusting temperatures of powder surrounding the 3D object in the powder bed in accordance with results of the analyzing to prevent microcrack formation in the 3D object.

### BACKGROUND

The present disclosure generally relates to powder fusion manufacturing. More specifically, the present disclosure relates to a method and a system for an intelligent thermal control system for laser-based three dimensional (3D) powder fusion manufacturing to prevent microcrack formation.

Powder Bed Fusion (PBF) is an advanced additive manufacturing process that revolutionizes the production of intricate and customized components. It involves depositing a fine layer of powdered material and using a high-energy source, typically a laser or electron beam, to selectively melt or sinter the powder, layer by layer, into a solid object. This method offers several significant advantages. Firstly, PBF enables the creation of complex and lightweight structures that are challenging or impossible to manufacture using traditional methods. Secondly, it reduces material waste, as only the necessary powder is used in the process, making it more environmentally friendly. Moreover, PBF offers excellent design flexibility, allowing for rapid prototyping and customized production, and it excels in producing high-strength, precise parts with superb mechanical properties. These benefits have made PBF a game-changer in industries ranging from aerospace and healthcare to automotive and beyond.

### SUMMARY

According to an aspect of the disclosure, a method for thermal control of laser-based three dimensional (3D) powder fusion manufacturing is provided. The method includes directing a laser beam into a powder bed for fabricating a 3D object by powder bed fusion, analyzing historical data and powder specifications relating to the 3D object and powder in the powder bed and dynamically adjusting temperatures of powder surrounding the 3D object in the powder bed in accordance with results of the analyzing to prevent microcrack formation in the 3D object.

According to an aspect of the disclosure, a system for thermal control of laser-based three dimensional (3D) powder fusion manufacturing is provided. The system includes an enclosure defining a powder bed, an optical system to emit a laser beam toward the powder bed, a secondary heating system and a controller. The controller is configured to control the optical system to direct the laser beam into the powder bed for fabricating a 3D object by powder bed fusion, to analyze historical data and powder specifications relating to the 3D object and the powder in the powder bed and to control the secondary heating system to dynamically adjust temperatures of powder surrounding the 3D object in the powder bed in accordance with analysis results to prevent microcrack formation in the 3D object.

According to an aspect of the disclosure, a system for thermal control of laser-based three dimensional (3D) powder fusion manufacturing is provided. The system includes an enclosure defining a powder bed, an optical system to emit a laser beam toward the powder bed, a secondary optical system to emit a secondary laser beam toward the powder bed and a controller. The controller is configured to control the optical system to direct the laser beam into the powder bed for fabricating a 3D object by powder bed fusion, to analyze historical data and powder specifications relating to the 3D object and the powder in the powder bed and to control the secondary optical system to direct the secondary laser beam into the powder bed to dynamically adjust temperatures of powder surrounding the 3D object in the powder bed in accordance with analysis results to prevent microcrack formation in the 3D object.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the disclosure are apparent from the following detailed description taken in conjunction with the accompanying drawings in which:

FIG. 1 is a schematic diagram of a computing environment for executing thermal control of laser-based 3D powder fusion manufacturing in accordance with one or more embodiments of the present invention;

FIG. 2 is a flow diagram illustrating a method for thermal control of laser-based 3D powder fusion manufacturing in accordance with one or more embodiments of the present invention;

FIG. 3 is a schematic diagram of a system for executing the method of thermal control of laser-based 3D powder fusion manufacturing of FIG. 3 in accordance with one or more embodiments of the present invention; and

FIG. 4 is a schematic diagram of a controller of the system of FIG. 3 in accordance with one or more embodiments of the present invention.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

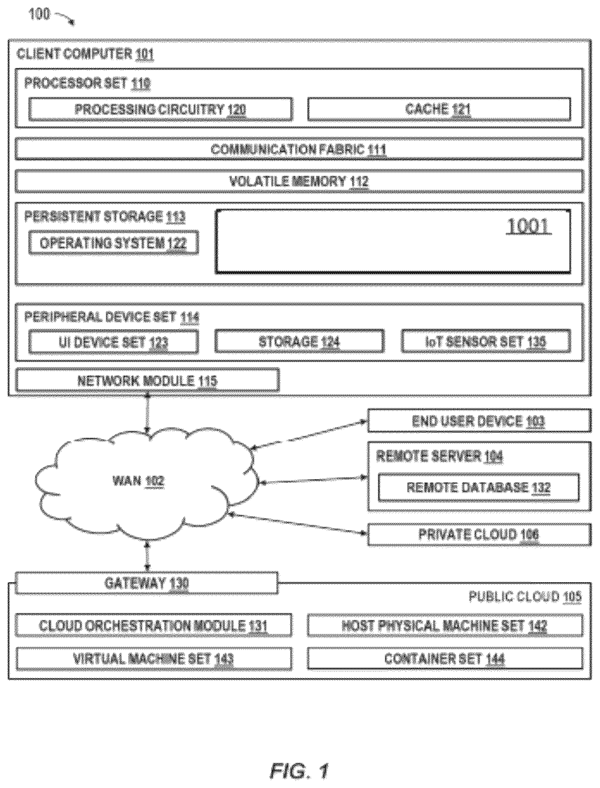

With reference to FIG. 1, a computer or computing device 100 that implements a computer-implemented method for thermal control of laser-based 3D powder fusion manufacturing is provided in accordance with one or more embodiments of the present invention is provided. The computer or computing device 100 of FIG. 1 contains an example of an environment for the execution of at least some of the computer code involved in performing the inventive methods, such as the block 1001 of the computer-implemented method for thermal control of laser-based 3D powder fusion manufacturing. In addition to the computer-implemented method for thermal control of laser-based 3D powder fusion manufacturing of block 1001, the computer or computing device 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the computer-implemented method of block 1001, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

The computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of the computer-implemented method, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

The processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In the computer-implemented method, at least some of the instructions for performing the inventive methods may be stored in the block 1001 of the computer-implemented method in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the block 1001 of the computer-implemented method typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud

For the sake of brevity, conventional fabrication techniques may or may not be described in detail herein. Moreover, the various tasks and process steps described herein can be incorporated into a more comprehensive procedure or process having additional steps or functionality not described in detail herein. In particular, various steps in the manufacture of certain types of devices are well known and so, in the interest of brevity, many conventional steps will only be mentioned briefly herein or will be omitted entirely without providing the well-known process details.

Turning now to an overview of technologies that are more specifically relevant to aspects of the disclosure, powder bed fusion manufacturing offers several advantages. Powder bed fusion allows for the creation of intricate and complex 3D shapes that are challenging or impossible to achieve with traditional manufacturing methods. This capability is particularly valuable in industries where complex geometries are essential for product performance. Manufacturers can quickly iterate and customize designs without incurring significant tooling costs. This flexibility is crucial for rapid prototyping and adapting to changing customer demands. As an additive manufacturing process, powder bed fusion builds objects layer by layer, minimizing material waste compared to subtractive manufacturing methods where material is removed from a solid block. This reduces material costs and environmental impact. Powder bed fusion offers exceptional precision and accuracy in producing parts. The layer-by-layer approach allows for tight tolerances and fine control over dimensions, which is critical for parts that need to fit precisely.

While powder fusion techniques, such as powder bed fusion (PBF) or selective laser sintering (SLS), are popular in additive manufacturing, they do come with certain challenges and limitations. Uneven heating and cooling during the fusion process can lead to thermal stresses and distortions in the printed parts. Thermal issues may also cause warping and cracking in large or complex geometries. Improper cooling rates in the powder bed fusion additive manufacturing process, such as selective laser melting (SLM) or electron beam melting (EBM), can contribute to the formation of microcracks in the 3D printed object. In powder bed fusion processes, melted material is rapidly cooled after being fused by an energy beam. If the cooling rate is too high or uneven, it can lead to the formation of thermal stresses within the material. Rapid cooling creates temperature gradients within the material, and the uneven distribution of thermal stresses can result in the development of microcracks. Rapid solidification of the melted material can lead to the accumulation of residual stresses in the printed object. If these stresses are not relieved through proper heat treatment or stress relief processes, they can contribute to the initiation and propagation of microcracks. Solidification cracking is a specific type of crack formation that occurs during the solidification of the melt pool. If the cooling rate is too high, it can result in the creation of cracks at the grain boundaries as the material solidifies. These cracks can propagate through the structure and become visible on the surface. Insufficient control over the cooling rate may hinder the refinement of the grain structure. A refined grain structure is often desirable for improved mechanical properties. If the material cools too quickly, the grains may not have sufficient time to grow uniformly, and this can result in a coarser microstructure prone to cracking. Different materials used in powder bed fusion have specific cooling rate requirements to achieve optimal properties. For instance, certain alloys may be more susceptible to cracking if they cool too rapidly. Understanding the material's behavior during solidification is crucial to avoiding microcracks.

Thus, it is apparent that in laser-based 3D manufacturing with powder fusion, microcrack formation is a common challenge due to inadequate cooling rates. Current systems lack real-time assessment and control, risking flawed objects.

Turning now to an overview of the aspects of the disclosure, one or more embodiments of the disclosure address the above-described shortcomings of the prior art by integrating a synchronized approach, utilizing a secondary heat beam to manage cooling rates. This innovation ensures precise temperature control, minimizing microcracks during the production of 3D objects and enhancing the quality of the manufacturing process.

The proposed system will consider historical learning regarding the pattern of microcrack formation on the 3D object with respect to cooling rate and will analyze the specifications of the powder material, such as melting point, heat transfer coefficient, specific heat, etc., and accordingly will identify the extent of additional temperature elevation needed on the powder materials around the 3D object being manufactured. This increased surrounding temperature on the powder material aims to control the heat transfer from the object being manufactured and, consequently, mitigate the risk of microcrack formation. Based on the powder material specifications, the required melting temperature for powder fusion using a laser and the necessary cooling rate, the proposed system will identify the temperature difference that needs to be maintained between the fused powder material and the surrounding powder material covering it. Subsequently, a secondary heat generation beam will be applied to the powder materials around the fused powder material accordingly, so both the laser beam based fusion module and secondary heat generation system will be working in a synchronized manner. The system will evaluate the real-time cooling rate of the 3D object being manufactured and subsequently will dynamically identify the appropriate combination of temperature for the secondary heat generation module and the boundary range around the 3D object being manufactured. This is done to maintain the required cooling rate as needed to avoid microcracks. Based on the geometry and dimensions of the 3D object to be manufactured with powder fusion, the system will consider historical learning to segment the 3D object, identifying areas where micro-cracks might appear. Accordingly, the system will create a secondary extended boundary around the 3D object to be manufactured, where the powder material will have an appropriate level of temperature differences to maintain the cooling rate. Based on the heat generation capability of the secondary heat beam generation module, an allowed level of temperature of the surrounding powder material and the cooling rate can be controlled so that the powder present around the secondary zone is not fused. The system will then dynamically calculate the layer thickness of the powder material to maintain the necessary temperature difference to control the cooling rate effectively. The system will dynamically determine the necessity of pre-heating and post-heating around the powder fusion area for creating the 3D object to ensure that a controlled cooling rate can be maintained for the 3D object.

Turning now to an overview of the aspects of the disclosure, one or more embodiments of the disclosure address the above-described shortcomings of the prior art by providing a method for thermal control of laser-based 3D powder fusion manufacturing. The method includes directing a laser beam into a powder bed for fabricating a 3D object by powder bed fusion, analyzing historical data and powder specifications relating to the 3D object and powder in the powder bed and dynamically adjusting temperatures of powder surrounding the 3D object in the powder bed in accordance with results of the analyzing to prevent microcrack formation in the 3D object.

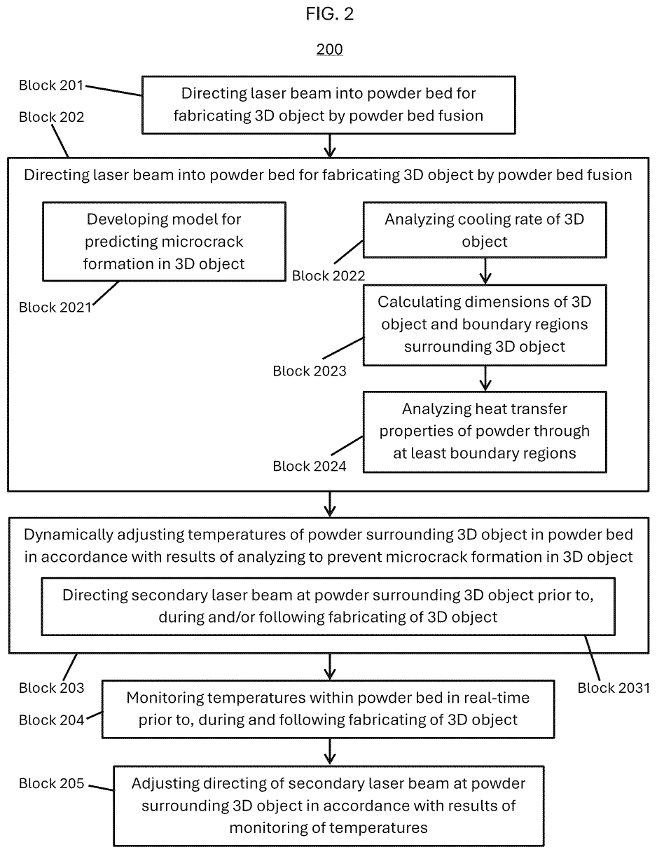

With reference to FIG. 2, a method 200 for thermal control of laser-based 3D powder fusion manufacturing is provided. The method 200 includes directing a laser beam into a powder bed for fabricating a 3D object by powder bed fusion (block 201) analyzing historical data and powder specifications relating to the 3D object and powder in the powder bed (block 202) and dynamically adjusting temperatures of powder surrounding the 3D object in the powder bed in accordance with results of the analyzing to prevent microcrack formation in the 3D object (block 203) by, for example, directing a secondary laser beam at the powder surrounding the 3D object prior to, during and/or following the fabricating of the 3D object (block 2031). The historical data and the powder specifications relating to the 3D object can include at least one or more of dimensions of the 3D object, historical data of microcracking of the 3D object and cooling rates of different sections of the 3D object. The historical data and the powder specifications relating to the powder in the powder bed can include at least one or more of a melting point, a specific heat and a thermal conductivity of the powder in the powder bed. The analyzing of the historical data and the powder specifications of block 202 can include developing a model for predicting microcrack formation in the 3D object (block 2021) and/or at least one or more of analyzing a cooling rate of the 3D object (block 2022), calculating dimensions of the 3D object and boundary regions surrounding the 3D object (block 2023) and analyzing heat transfer properties of the powder through at least the boundary regions (block 2024).

The method 200 can further include one or more feedback loops including monitoring temperatures within the powder bed in real-time prior to, during and following the fabricating of the 3D object (block 204) and adjusting the directing of the secondary laser beam at the powder surrounding the 3D object in accordance with results of the monitoring of the temperatures (block 205).

The method 200 of FIG. 2 can include identifying portions around 3D objects manufactured with laser-based powder fusion where microcracks can form due to inappropriate cooling rates by gathering detailed information on powder material properties, including melting point, specific heat, thermal conductivity and other relevant characteristics; performing non-destructive testing methods, such as X-ray scanning or other advanced imaging techniques to detect microcracks that may have formed; performing visual analysis of the 3D object to identify the geometry and shape of different portions of the 3D object and calculating the volume of solidified material on the 3D object; collecting the cooling rate or heat dissipation rate from the 3D object; analyzing the shape and dimensions of the 3D object and noting intricate features, thin sections and complex geometries that may be susceptible to uneven cooling; conducting thermal simulations to predict temperature distributions during and after the laser-based powder fusion process by integrating material properties, geometry and cooling rates into the simulation model; integrating machine learning algorithms to analyze historical data and simulation results and training the model to identify patterns and correlations between powder material properties, geometry, and the occurrence of microcracks; developing a database or model that correlates these properties with the likelihood of micro-crack formation; conducting real-time temperature monitoring by continuously monitoring and recording temperature changes and providing feedback to adjust cooling rates dynamically; conducting real-time scanning along with post-manufacturing scans to identify areas where micro-cracks have formed; correlating data from real-time monitoring, thermal simulations and scanning results and identifying regions where actual cooling rates deviate significantly from the predicted rates leading to micro-crack formation; establishing critical thresholds for various parameters, such as temperature differentials and cooling rates and identifying portions of the 3D object where these thresholds are exceeded, indicating a higher risk of microcracks; adjusting secondary heating systems to control a cooling rate on the 3D object; and identifying portions around the 3D object where microcracks can form due to inappropriate cooling.

The method 200 can include analyzing powder material specification and heat transfer through the powder materials by receiving specifications of powder material including melting point, heat transfer coefficient and specific heat; performing heat transfer calculations based on temperatures generated to fuse the powder material and estimating what should be the temperature of the adjacent powder materials; calculating a required degree of heat transfer which can maintain required cooling rates and accordingly calculating the required temperature of the powder material adjacent to the 3D object; analyzing the geometry and dimensions of the 3D object using historical rates of heat transfer from different geometries; preventing adjacent powder material temperatures from being more than threshold limits to control heat transfer and hence control cooling; identifying how much volume of the surrounding powder will create a heat transfer protection layer; creating a secondary extended boundary around the 3D object ensuring appropriate temperature differences for maintaining the cooling rate.

The method 200 can include using programmatic controlled secondary heating systems to increase temperatures of powder material around the 3D object with real-time temperature monitoring; utilizing a secondary heat or laser beam to adjust surrounding powder temperatures, dynamically calculating layer thickness and applying pre/post-heating for controlled 3D object cooling.

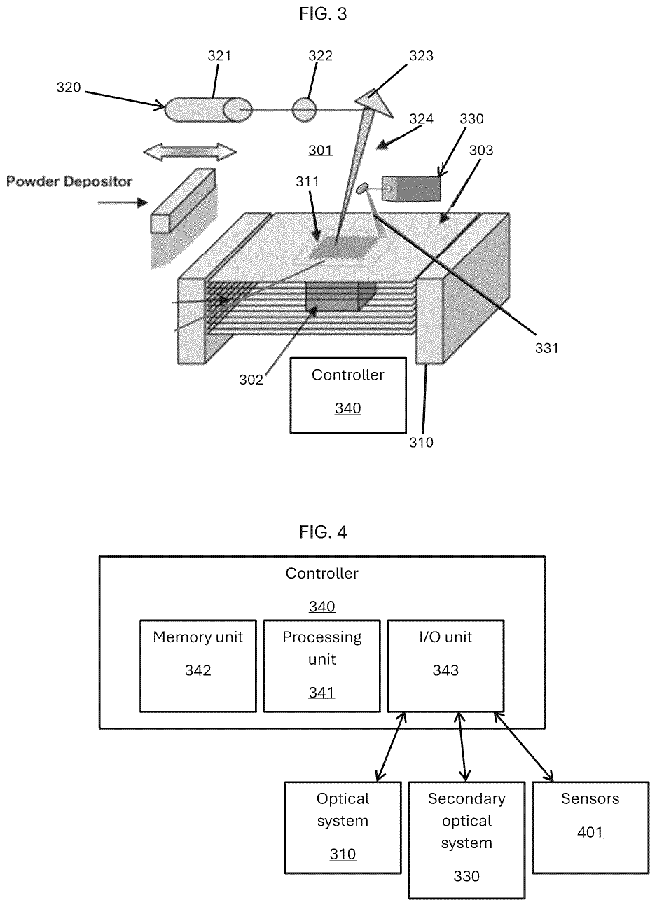

With reference to FIG. 3, a system 301 for thermal control of laser-based 3D powder fusion manufacturing is provided and is capable of executing the method 200 of FIG. 2. The system 301 includes an enclosure 310 defining a powder bed 311, an optical system 320 including a laser emitter 321, optics 322 and a scanning mirror 323 to emit a laser beam 324 toward the powder bed 311 and heating system, which can include or be provided as a secondary optical system 330 to emit a secondary laser beam 331 toward the powder bed 311 and a controller 340. It is to be understood that, as used herein, the phrase “heating system” can refer to any type of heating system (i.e., laser, electrically resistive, heated air flow, etc.); however, for purposes of clarity and brevity, the following description will generally relate to the case of the heating system being provided as the secondary optical system 330.

With reference to FIG. 4, the controller 340 can include a processing unit 341, a memory unit 342 and an input/output (I/O) unit 343 by which the processing unit 341 is communicative with the other elements and features of the system 301. The memory unit 342 has executable instructions stored thereon which are readable and executable by the processing unit 341. When the executable instructions are read and executed by the processing unit 341, the controller 340 as a whole is caused to operate generally as described herein. That is, when the executable instructions are read and executed by the processing unit 341, the controller 340 controls the optical system 320 to direct the laser beam 324 into the powder bed 311 for fabricating a 3D object 302 by powder bed fusion, analyzes historical data and powder specifications relating to the 3D object 302 and the powder 303 in the powder bed 311 and control the secondary optical system 330 to direct the secondary laser beam 331 into the powder bed 311 to dynamically adjust temperatures of powder 303 surrounding the 3D object 302 in the powder bed 311 prior to, during and following the fabricating of the 3D object 302 in accordance with analysis results to prevent microcrack formation in the 3D object 302.

For the system 301, the historical data and the powder specifications relating to the 3D object 302 can include at least one or more of dimensions of the 3D object 302, historical data of microcracking of the 3D object 302 and cooling rates of different sections of the 3D object 302, and the historical data and the powder specifications relating to the powder 303 in the powder bed 311 can include at least one or more of a melting point, a specific heat and a thermal conductivity of the powder 303 in the powder bed 311. As such, the analyzing of the historical data and the powder specifications relating to the 3D object 302 by the controller 340 can include developing a model for predicting microcrack formation in the 3D object 302 by the controller 340. In addition, the analyzing of the historical data and the powder specifications by the controller 340 can include at least one or more of analyzing a cooling rate of the 3D object 302 by the controller 340, calculating dimensions of the 3D object 302 and boundary regions surrounding the 3D object 302 by the controller 340 and analyzing heat transfer properties of the powder 303 through at least the boundary regions by the controller 340.

With continued reference to FIGS. 3 and 4, the system 301 can further include sensors 401 (see FIG. 4) that are communicative with the controller 340 and that are deployable throughout the system 301. In these or other cases, the sensors 401 serve to monitor temperatures within the powder bed 311 in real-time prior to, during and following the fabricating of the 3D object 302 and the adjusting, by the controller 340, the directing of the secondary laser beam 331 at the powder 303 surrounding the 3D object 302 can be in accordance with results of the monitoring of the temperatures by the sensors 401.

Various embodiments of the present disclosure are described herein with reference to the related drawings. Alternative embodiments can be devised without departing from the scope of this disclosure. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to semiconductor device and integrated circuit (IC) fabrication may or may not be described in detail herein. By way of background, however, a more general description of the semiconductor device fabrication processes that can be utilized in implementing one or more embodiments of the present disclosure will now be provided. Although specific fabrication operations used in implementing one or more embodiments of the present disclosure can be individually known, the described combination of operations and/or resulting structures of the present disclosure are unique. Thus, the unique combination of the operations described in connection with the fabrication of a semiconductor device according to the present disclosure utilize a variety of individually known physical and chemical processes performed on a semiconductor (e.g., silicon) substrate, some of which are described in the immediately following paragraphs.

In general, the various processes used to form a micro-chip that will be packaged into an IC fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), and chemical-mechanical planarization (CMP), and the like. Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modern microelectronic device. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a transistor and the many wires that connect the millions of transistors of a circuit, lithography and etch pattern transfer steps are repeated multiple times. Each pattern being printed on the wafer is aligned to the previously formed patterns and slowly the conductors, insulators and selectively doped regions are built up to form the final device.

The flowchart and block diagrams in the Figures illustrate possible implementations of fabrication and/or operation methods according to various embodiments of the present disclosure. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present disclosure have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for thermal control of laser-based three dimensional (3D) powder fusion manufacturing, the method comprising:
directing a laser beam into a powder bed for fabricating a 3D object by powder bed fusion;
analyzing historical data and powder specifications relating to the 3D object and powder in the powder bed; and
dynamically adjusting temperatures of powder surrounding the 3D object in the powder bed in accordance with results of the analyzing to prevent microcrack formation in the 3D object.

2. The method according to claim 1, wherein the historical data and the powder specifications relating to the 3D object comprise at least one or more of dimensions of the 3D object, historical data of microcracking of the 3D object and cooling rates of different sections of the 3D object.

3. The method according to claim 1, wherein the historical data and the powder specifications relating to the powder in the powder bed comprise at least one or more of a melting point, a specific heat and a thermal conductivity of the powder in the powder bed.

4. The method according to claim 1, wherein the analyzing of the historical data and the powder specifications comprises developing a model for predicting microcrack formation in the 3D object.

5. The method according to claim 1, wherein the analyzing of the historical data and the powder specifications comprises at least one or more of:
analyzing a cooling rate of the 3D object;
calculating dimensions of the 3D object and boundary regions surrounding the 3D object; and
analyzing heat transfer properties of the powder through at least the boundary regions.

6. The method according to claim 1, wherein the dynamically adjusting of the temperatures of the powder surrounding the 3D object in the powder bed comprises directing a secondary laser beam at the powder surrounding the 3D object.

7. The method according to claim 6, further comprising:
monitoring temperatures within the powder bed in real-time prior to, during and following the fabricating of the 3D object; and
adjusting the directing of the secondary laser beam at the powder surrounding the 3D object in accordance with results of the monitoring of the temperatures.

8. The method according to claim 6, wherein the directing of the secondary laser beam at the powder surrounding the 3D object is executed prior to, during and following the fabricating of the 3D object.

9. A system for thermal control of laser-based three dimensional (3D) powder fusion manufacturing, the system comprising:
an enclosure defining a powder bed;
an optical system to emit a laser beam toward the powder bed;
a secondary heating system; and
a controller configured to control the optical system to direct the laser beam into the powder bed for fabricating a 3D object by powder bed fusion, to analyze historical data and powder specifications relating to the 3D object and the powder in the powder bed and to control the secondary heating system to dynamically adjust temperatures of powder surrounding the 3D object in the powder bed in accordance with analysis results to prevent microcrack formation in the 3D object.

10. The system according to claim 9, wherein:
the historical data and the powder specifications relating to the 3D object comprise at least one or more of dimensions of the 3D object, historical data of microcracking of the 3D object and cooling rates of different sections of the 3D object, and
the historical data and the powder specifications relating to the powder in the powder bed comprise at least one or more of a melting point, a specific heat and a thermal conductivity of the powder in the powder bed.

11. The system according to claim 9, wherein the analyzing of the historical data and the powder specifications by the controller comprises developing a model for predicting microcrack formation in the 3D object by the controller.

12. The system according to claim 9, wherein the analyzing of the historical data and the powder specifications by the controller comprises at least one or more of:
analyzing a cooling rate of the 3D object by the controller;
calculating dimensions of the 3D object and boundary regions surrounding the 3D object by the controller; and
analyzing heat transfer properties of the powder through at least the boundary regions by the controller.

13. The system according to claim 9, further comprising:
sensors to monitor temperatures within the powder bed in real-time prior to, during and following the fabricating of the 3D object; and
the dynamically adjusting of the temperatures of the powder surrounding the 3D object in the powder bed is executed by the controller in accordance with results of the monitoring of the temperatures by the sensors.

14. The system according to claim 9, wherein the dynamically adjusting of the temperatures of the powder surrounding the 3D object in the powder bed is executed by the controller prior to, during and following the fabricating of the 3D object.

15. A system for thermal control of laser-based three dimensional (3D) powder fusion manufacturing, the system comprising:
an enclosure defining a powder bed;
an optical system to emit a laser beam toward the powder bed;
a secondary optical system to emit a secondary laser beam toward the powder bed; and
a controller configured to control the optical system to direct the laser beam into the powder bed for fabricating a 3D object by powder bed fusion, to analyze historical data and powder specifications relating to the 3D object and the powder in the powder bed and to control the secondary optical system to direct the secondary laser beam into the powder bed to dynamically adjust temperatures of powder surrounding the 3D object in the powder bed in accordance with analysis results to prevent microcrack formation in the 3D object.

16. The system according to claim 15, wherein:
the historical data and the powder specifications relating to the 3D object comprise at least one or more of dimensions of the 3D object, historical data of microcracking of the 3D object and cooling rates of different sections of the 3D object, and
the historical data and the powder specifications relating to the powder in the powder bed comprise at least one or more of a melting point, a specific heat and a thermal conductivity of the powder in the powder bed.

17. The system according to claim 15, wherein the analyzing of the historical data and the powder specifications by the controller comprises developing a model for predicting microcrack formation in the 3D object by the controller.

18. The system according to claim 15, wherein the analyzing of the historical data and the powder specifications by the controller comprises at least one or more of:
analyzing a cooling rate of the 3D object by the controller;
calculating dimensions of the 3D object and boundary regions surrounding the 3D object by the controller; and
analyzing heat transfer properties of the powder through at least the boundary regions by the controller.

19. The system according to claim 15, further comprising:
sensors to monitor temperatures within the powder bed in real-time prior to, during and following the fabricating of the 3D object; and
adjusting, by the controller, the directing of the secondary laser beam at the powder surrounding the 3D object in accordance with results of the monitoring of the temperatures by the sensors.

20. The system according to claim 15, wherein the directing of the secondary laser beam at the powder surrounding the 3D object is executed by the controller prior to, during and following the fabricating of the 3D object.
